(19) United States
(12) Patent Application Publication
(10) Pub. No.: US 2008/0238880 A1
(43) Pub. Date: Oct. 2, 2008

(54) IMAGE DISPLAY DEVICE, IMAGE CORRECTION CONTROL DEVICE, AND IMAGE CORRECTION PROGRAM

(75) Inventor: Tomoaki MIWA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/059,866

(22) Filed: Mar. 31, 2008

(30) Foreign Application Priority Data
Mar. 30, 2007 (JP) 2007-093024

(51) Int. Cl. G06F 3/041

(52) U.S. Cl. 345/173

(57) ABSTRACT

An image display device has a touchpad and an image display area that is composed of a plurality of sub-areas obtained by dividing the image display area into a two-dimensional array. A sensor surface of the touchpad is positionally correlated to the image display area. In response to a touch on the touchpad, the image display device specifies one or more of the sub-areas and adjusts the brightness of the specified sub-areas. In addition, the image display device specifies a different portion of the display image in response to a different user operation, such as a user operation of touching the touchpad with his finger and moving the finger across the touchpad, two successive user operations, or a user operation made at a specific tracing speed.

### BACKGROUND OF THE INVENTION

(1) Field of the Invention

The present invention relates to image display devices and especially to an image correction technique.

(2) Description of the Related Art

Various schemes have been suggested and used to select a portion of a display image to be corrected.

Mobile phones generally employ an image correction technique according to which a display image is corrected by uniformly adjusting the brightness of the entire image.

According to another image correction technique, any human faces contained in a display image are detected to locally adjust the brightness of portions of the image corresponding to the detected human faces.

Under these circumstances, it is desired that compact devices such as mobile phones allow users to selectively correct any portion of a display image.

### SUMMARY OF THE INVENTION

According to one aspect of the present invention, an image display device includes: a touchpad operable to detect a touch point at which a user operation of touching the touchpad is made; a display unit operable to display an image on a display area that includes a plurality of sub-areas; and a brightness adjusting unit operable to specify one or more of the sub-areas based on the touch point and adjust brightness of the specified one or more sub-areas.

According to another aspect of the present invention, an image correction control device includes: an acquiring unit operable to acquire a touch point at which a user operation of touching a touchpad is made; and a control unit operable to (i) specify one or more of sub-areas that together constitute a display area of a display that is for displaying an image thereon and (ii) adjust brightness of the specified one or more sub-areas.

Here, to “adjust the brightness” refers to change the intensity values of pixels of a specified portion of a display image.

According to yet another aspect of the present invention, an image correction program for execution by a computer of an image display device, the display device having a touchpad and a display unit for displaying an image on a display area composed of a plurality of sub-areas. The program includes code operable to cause the computer to perform the following steps to adjust brightness of the image: a detecting step of detecting a touch point at which a user operation of touching the touchpad is made; and a brightness adjusting step of specifying one or more of the sub-areas based on the touch point and adjust brightness of the one or more sub-areas.

### BRIEF DESCRIPTION OF THE DRAWINGS

These and the other objects, advantages and features of the invention will become apparent from the following description thereof taken in conjunction with the accompanying drawings which show a specific embodiment of the invention.

In the drawings:

FIG. 1 is a block diagram showing the functional structure of a mobile phone 100 according to an embodiment of the present invention;

FIG. 2 is an external view of the mobile phone 100;

FIG. 3 shows an example of a coordinate-key assignment table 151;

FIG. 4 shows an example of a key-area assignment table 152;

FIG. 5 shows a flowchart of the processing steps performed by the mobile phone 100 to execute a rectangular-area correction;

FIG. 6 shows a flowchart of the processing steps performed by the mobile phone 100 to further make an image correction subsequently to another image correction;

FIGS. 7A-7C show a specific example of a rectangular-area correction of increasing the image brightness;

FIGS. 8A-8C show a specific example of a rectangular-area correction of further increasing the image brightness previously corrected;

FIGS. 9A-9C show a specific example of an image correction of decreasing the image brightness;

FIG. 10 shows a flowchart of the processing steps performed by the mobile phone 100 to execute a non-rectangular-area correction;

FIGS. 11A-11C show a specific example of a non-rectangular-area correction of further increasing the image brightness previously corrected;

FIGS. 12A-12C show a specific example of a non-rectangular-area correction of increasing the image brightness;

FIG. 13 shows a flowchart of the processing steps performed by the mobile phone 100 in response to a second user operation made subsequently to a first user operation;

FIGS. 14A-14C show a specific example of a non-rectangular-area correction of further increasing the image brightness previously corrected;

FIGS. 15A-15C show a specific example of a non-rectangular-area correction of decreasing the image brightness;

FIGS. 16A-16C show a specific example of a non-rectangular-area correction of increasing the image brightness of a portion specified in response to a second user operation and in view a first user operation;

FIG. 17 shows a flowchart of the processing steps performed by the mobile phone 100 to execute a non-rectangular-area correction;

FIGS. 18A-18C show a specific example of a non-rectangular-area correction executed in response to a user operation of tracing a circular path;

FIGS. 19A-19C show a specific example of a non-rectangular-area correction executed in response to a user operation of continually touching a single point;

FIG. 20 shows a flowchart of the processing steps performed by the mobile phone 100 to execute an image correction in accordance with the duration of a user operation;

FIGS. 21A-21C show specific examples of the display images corrected in response to a user operation made at a different tracing speed;

FIG. 22 is a flowchart of the processing steps performed by the mobile phone 100 to execute an image correction in response to first and second user operations defining paths that intersect with each other;

FIGS. 23A-23C show a specific example of a non-rectangular-area correction executed in response to first and second user operations defining paths that intersect with each other;

FIGS. 24A-24C show a specific example of a non-rectangular-area correction according to a modification of the present invention;

FIGS. 25A-25C show a specific example of an image correction executed in response to a user operation made to trace a curved path;

FIGS. 26A-26C show a specific example of an image correction executed to gradually adjust the image brightness; and

FIGS. 27A-27C show specific example of the display images corrected in response to a user operation made at a different tracing speed.

### DESCRIPTION OF THE PREFERRED EMBODIMENT

The following describes a mobile phone according to one embodiment of the present invention, with reference to the accompanying drawings.

### Embodiment

### 1. Structure

A mobile phone 100 according to the embodiment of the present invention provides a so-called Smooth Touch function realized by a ten-key pad of which surface doubles as a sensor surface of a touchpad. The present invention relates to an image correction performed in response to a user operation made on the touchpad. Note that a user operation may be abbreviated to “UO” in the figures.

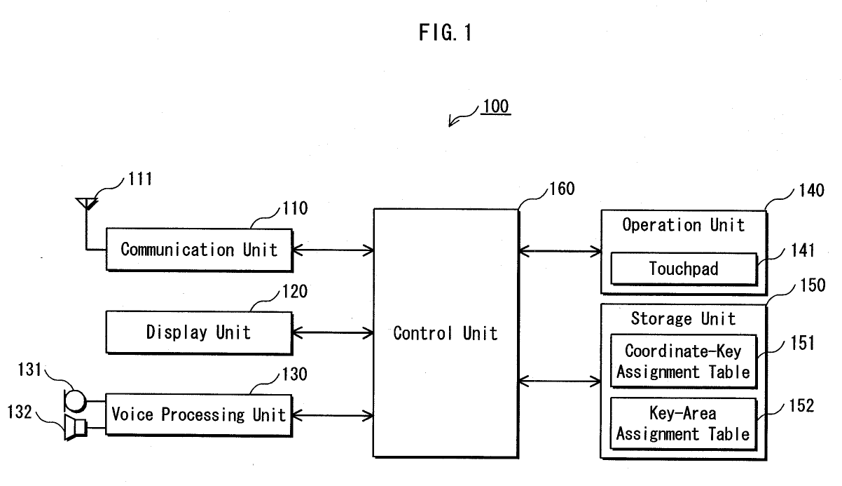

FIG. 1 is a block diagram showing the functional structure of the mobile phone 100. As shown in FIG. 1, the mobile phone 100 includes a communication unit 110, a display unit 120, a voice processing unit 130, an operation unit 140, a storage unit 150, and a control unit 160.

Upon receipt of a signal via an antenna 111, the communication unit 110 demodulates the received signal into incoming voice and data signals and outputs the resulting signals to the control unit 160. Upon receipt of an outgoing voice signal having been A/D converted by the voice processing unit 130 and an outgoing data signal indicative of e-mail from the control unit 160, the communication unit 110 modulates the outgoing signals and outputs the resulting signals via the antenna 111.

The display unit 120 includes a display that is realized by an LCD (Liquid Crystal Display), for example. Under control by the control unit 160, the display unit 120 displays an image on an image display area 121 of the display. The image display area 121 will be described later in detail.

The voice processing unit 130 D/A converts an incoming voice signal received from the communication unit 110 and outputs the resulting signal to a speaker 132. In addition, the voice processing unit 130 A/D converts an outgoing voice signal acquired via a microphone 131 and outputs the resulting signal to the control unit 160.

The operation unit 140 has various operation keys including keys of a ten-key pad, an on-hook key, an off-hook key, direction keys, an enter key, and a mail key. The operation unit 140 receives a user operation made on the operation keys and outputs the received user operation to the control unit 160. In addition, the operation unit 140 includes a touchpad 141 that is sensitive to a touch by a user with his finger. The operation unit 140 detects the coordinates of a touch point on the touchpad 141 and outputs the detected coordinates to the control unit 160. Note that the sensor surface of the touchpad 141 coincides with the surface of the ten-key pad. The detection mechanism of the touchpad 141 is basically similar to a mechanism employed by a conventional touchpad. Thus, no detailed description of processing of the touchpad is given.

The storage unit 150 includes ROM (Read Only Memory) and RAM (Random Access Memory) and is realized by a compact hard disk or non-volatile memory. The storage unit 150 stores various data items and programs required for processing of the mobile phone 100 as well as music data and image data. In addition, the storage unit 150 stores a coordinate-key assignment table 151 and a key-area assignment table 152. The coordinate-key assignment table 151 shows the pairs of X and Y coordinate ranges defining areas of the touchpad 141 assigned to the respective keys of the ten-key pad of the operation unit 140. The key-area assignment table 152 shows the rectangular areas of the image display area 121 assigned to the respective keys of the ten-key pad. The coordinate-key assignment table 151 and the key-area assignment table 152 will be described later in more detail.

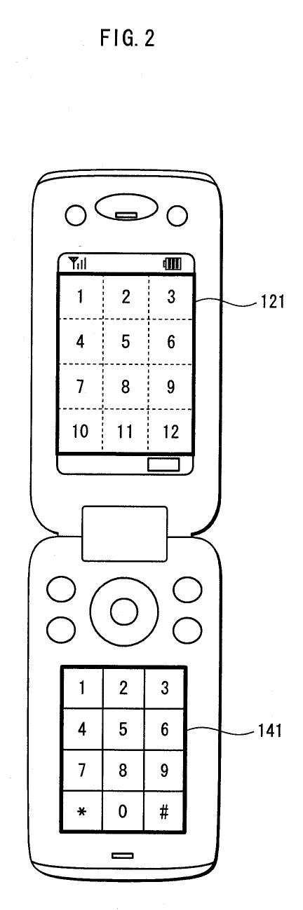

The control unit 160 controls the respective units of the mobile phone 100. The control unit 160 judges, based on setting information set in advance, whether a rectangular-area correction or a non-rectangular-area correction is selected. According to the judgment result, the control unit 160 specifies one or more of the rectangular areas or a portion of the image display area 121 corresponding to the coordinates detected on the touchpad 141. Subsequently, the control unit 160 corrects the brightness of the specified one or more of the rectangular areas or the specified portion of the image display area 121. Finally, the control unit 160 causes the display unit 120 to display the corrected image on the image display area 121. Note that in a “non-rectangular-area correction”, a portion of the display image to be corrected is specified in units other that the rectangular areas shown in FIG. 2.

More specifically, in the case where a rectangular-area correction is selected, the control unit 160 specifies, with reference to the coordinate-key assignment table 151 and the key-area assignment table 152, one or more of the rectangular areas corresponding to the coordinates detected by the touchpad 141 of the operation unit 140. Subsequently, the control unit 160 increases or decreases the brightness of a portion of the image displayed within the specified rectangular areas and causes the display unit 120 to display the thus corrected image on the image display area 121. Here, “to increase or decrease the brightness” means to change the intensify value of the relevant pixels.

On the other hand, in the case where a non-rectangular-area correction is selected, the control unit 160 transforms the coordinates detected on the touchpad 141 into corresponding coordinates on the image display area 121 of the display unit 120. Subsequently, the control unit 160 increases or decreases the brightness of a portion of the image displayed at the location specified by the transformed coordinates and causes the display unit 120 to display the thus corrected image on the image display area 121. The image display area 121 will be described later in more detail, with reference to FIG. 2.

In addition, the control unit 160 identifies the details of a user operation made on the touchpad 141 and selectively performs a correction process according to the details of the user operation. The description of the user operations and corresponding correction processes will be described later in more detail.

FIG. 2 is an external view of the mobile phone 100 and the image display area 121 is enclosed within the heavy line. As shown in FIG. 2, the image display area 121 where an image is displayed is divided into twelve rectangular areas. In addition, the image display area 121 has a 480×720 coordinate system with the origin point at the lower-left corner of the image display area 121. Each of the rectangular areas has a serially assigned number as shown in FIG. 2 and the relation between the assigned numbers and the rectangle areas is stored in the storage unit 150. Note that the numbers and doted lines are shown on the image display area 121 in FIG. 2 for purposes of illustration only. Naturally, those numbers and doted lines are not actually displayed.

In addition, the keys of the ten-key pad are arranged next to one another without leaving a gap therebetween so as to substantially form a single planer surface area. This surface of the ten-key pad acts as the sensor surface of the touchpad 141. Similarly to the image display area 121, the touchpad 141 has a 480×720 coordinate system with the origin point at the lower-left corner of the touchpad 141.

Although the coordinate systems of the touchpad 141 and of the image display area 121 according to the embodiment are mutually identical in scale, it is totally acceptable that the scales of the respective coordinate systems are mutually different. Since the correspondence relation is established between the respective coordinate systems, the control unit 160 is enabled to specify, in response to a user operation of touching a point on the touchpad 141, a corresponding point on the image display area 121. This configuration allows the user to specify a portion of the image displayed on the image display area 121 to be corrected, simply by touching a corresponding point on the touchpad 141.

### 2. Data

The following describes the coordinate-key assignment table 151 and the key-area assignment table 152 stored in the storage unit 150.

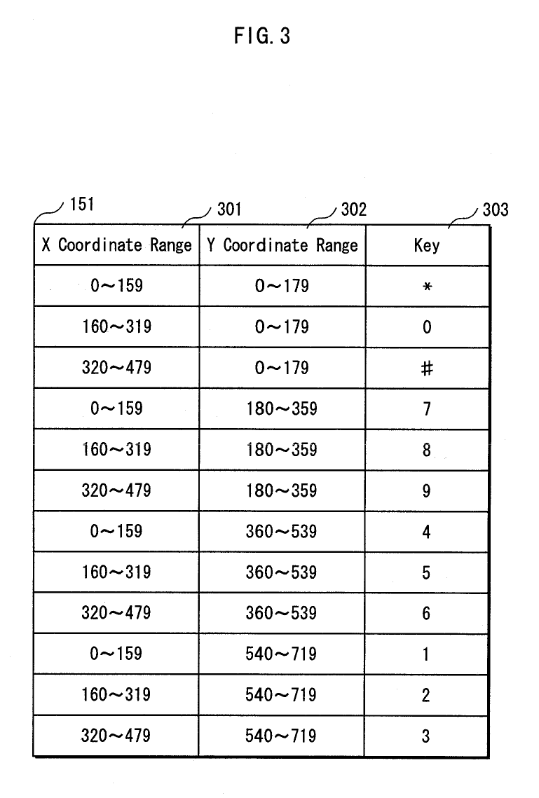

The coordinate-key assignment table 151 contains information used by the control unit 160 to specify a key corresponding to the coordinates of a touch point on the touchpad 141. More specifically, the coordinate-key assignment table 151 shows the respective keys of the ten-key pad and the corresponding coordinates defining rectangular areas of the touchpad 141. FIG. 3 shows one example of the coordinate-key assignment table 151.

As shown in FIG. 3, the coordinate-key assignment table 151 has columns of an X coordinate range 301, a Y coordinate range 302, and a key 303.

The X coordinate range column 301 stores the ranges of X coordinates in the coordinate system of the touchpad 141.

The Y coordinate range column 302 stores the ranges of Y coordinates in the coordinate system of the touchpad 141.

The key column 303 stores information indicating the keys of the ten-key pad assigned to the respective rectangular areas of the touchpad 141 that are defined by the pairs of X and Y coordinate ranges.

For example, a rectangular area of the touchpad 141 defined by the X coordinate range of 160-319 and the Y coordinate range of 0-179 is assigned to Key “0”. When, for example, the touchpad 141 detects the coordinates (172, 22), the control unit 160 specifies that Key “0” corresponds to the detected coordinates.

As described above, with reference to the coordinate-key assignment table 151, the control unit 160 specifies a key corresponding to a touch point detected by the touchpad 141.

Next, the key-area assignment table 152 is described.

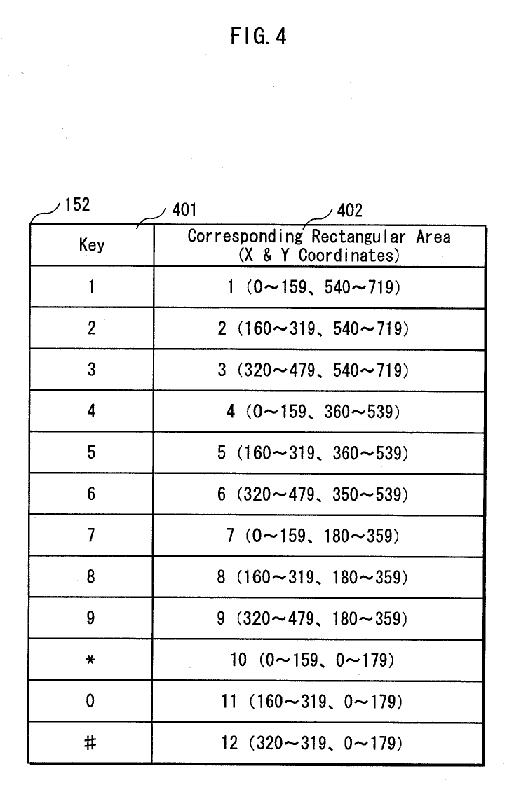

FIG. 4 shows an example of the key-area assignment table 152. As shown in FIG. 4, the key-area assignment table 152 has columns of a key 401 and a corresponding rectangular area 402.

The key column 401 stores information indicating the keys of the ten-key pad to be specified by the control unit 160 in response to a user operation.

The corresponding rectangular area column 402 stores information indicating the rectangular areas of the image display area 121 assigned to the respective keys of the ten-key pad.

For example, the key-area assignment table 152 shows that Key “3” is assigned to Rectangular Area “3” of the image display area 121. It is also shown that Rectangular Area “3” is described by the X coordinate range of 320-479 and the Y coordinate range of 540-719 in the coordinate system of the image display area 121.

In addition, in the case where the control unit 160 specifies that Key “#” corresponds to the coordinates detected by the touchpad 141, the control unit 160 specifies Rectangular Area “12” that corresponds to Key “#”.

As described above, with reference to the key-area assignment table 152, the control unit 160 specifies one of the rectangular areas of the image display area 121 corresponding to the key specified with reference to the coordinate-key assignment table 151. Note that the reason for providing two separate tables of the coordinate-key assignment table 151 and the key-area assignment table 152 is to allow for the case where the respective scales of the coordinate systems of the image display area 121 and of the touchpad 141 are mutually different.

### 3. Processing

The following describes the processing of the mobile phone 100 performed for executing the following correction processes.

### Correction Process 1

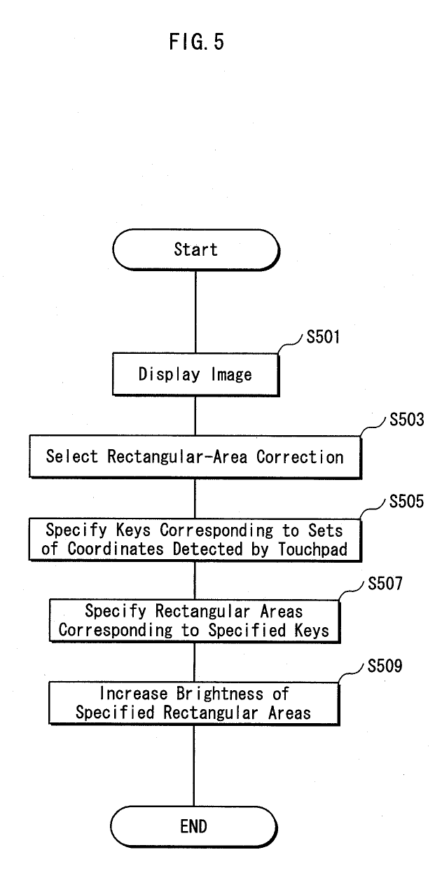

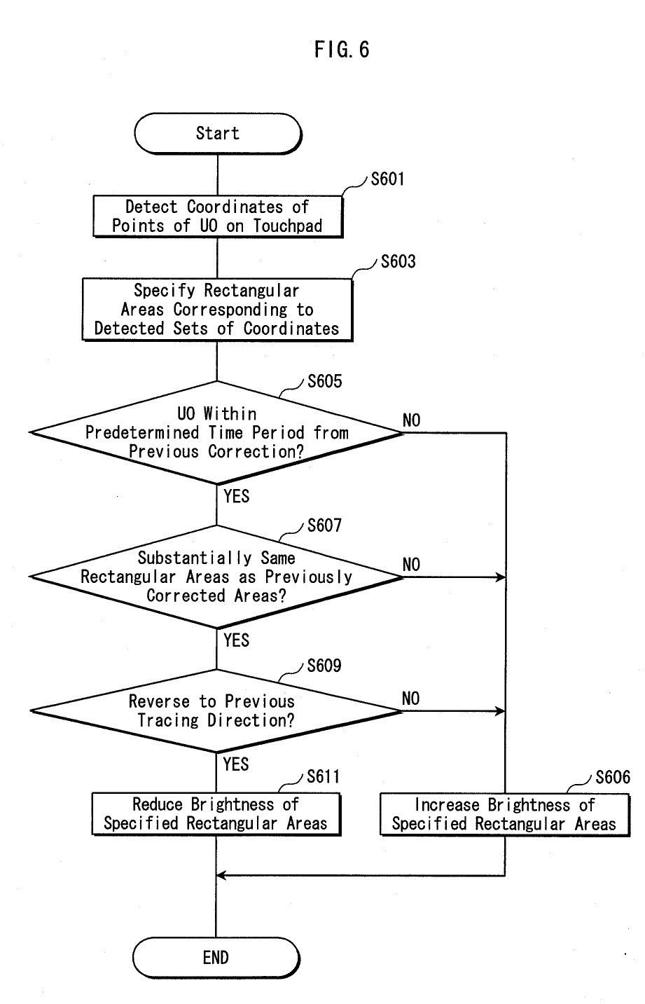

The following describes processing steps of the mobile phone 100 performed for executing a rectangular-area correction. The description is given with reference to flowcharts shown in FIGS. 5 and 6 and also with specific examples.

Under control by the control unit 160 of the mobile phone 100, the display unit 120 displays an image on the image display area 121 (Step S501).

In response to a user input such as a menu selection made on the operation unit 140, the control unit 160 stores into the storage unit 150 setting information indicating that rectangular-area correction is selected (Step S503).

In response to a subsequent user operation of touching one or more points on the touchpad 141, the touchpad 141 detects a pair of X and Y coordinates of each of the one or more touch points. The control unit 160 then searches the coordinate-key assignment table 151 to specify the X and Y coordinate ranges into which the detected X and Y coordinates fall and subsequently specifies one or more keys corresponding to the one or more touch points (Step S505).

The control unit 160 searches the key column 401 of the key-area assignment table 152 for each of the one or more specified keys and specifies a rectangular area of the image display area 121 corresponding to each of the one or more specified keys (Step S507).

The control unit 160 then performs an image correction to increase the brightness of each rectangular area specified out of the plurality of rectangular areas constituting the image display area 121 (Step S509). Note that the level of brightness to be increased through one correction process is determined in advance. In other words, an amount of intensity to be increased through one correction process is determined in advance.

The control unit 160 causes the display unit 120 to display the thus corrected image on the image display area 121.

The following describes the processing of the mobile phone 100 performed for making a further image correction subsequently to the above-described image correction, with reference to a flowchart shown in FIG. 6. FIG. 6 shows the flowchart of the processing steps performed by the mobile phone 100 to further make an image correction subsequently to another image correction.

As shown in FIG. 6, in response to a user operation made by moving his finger across the touchpad 141, the touchpad 141 sequentially detects a series of X and Y coordinates describing a path of the user operation (Step S601).

The control unit 160 specifies, with reference to the coordinate-key assignment table 151, every key corresponding to the user operation path. Subsequently, the control unit 160 specifies, with reference to the key-area assignment table 152, the rectangular areas of the image display area 121 corresponding to the specified keys (Step S603).

Next, the control unit 160 judges whether the user operation currently processed is made within a predetermined time period (five seconds, for example) from the previous correction (Step S605). In order to make this judgment in Step S605, the control unit 160 stores the time at which each correction is made, calculates a difference between the time of the immediately previous correction and the time at which the current user operation is received, and compares the calculated difference with a predetermined threshold.

When judging that the user operation is made within the predetermined time period from the previous correction (Step S605: YES), the control unit 160 further judges whether the rectangular areas of the image display area 121 specified in Step S603 are the same as the rectangular areas subjected to the previous correction (Step S607). This judgment in step S607 is made by storing information indicating the rectangular areas subjected to the previous correction and compares the rectangular areas indicated by the stored information with the rectangular areas specified in Step S603 in response to the current user operation.

When judging that the rectangular areas specified in Step S603 are the same as the rectangular areas subjected to the previous correction (Step S607: YES), the control unit 160 further judges whether the tracing direction of the current user operation is in reverse to the tracing direction of the previous user operation (Step S609). Note that the “tracing direction” refers to a direction from the start point to the end point of the path of a user operation that is made by continually touching the touchpad 141 with his finger and moving the finger across the touchpad 141. This judgment in Step S609 is made based on whether the rectangular areas which correspond to the series of coordinates sequentially detected by the touchpad 141 are specified in the same order or in the reverse order.

When judging that the tracing direction of the current user operation is in reverse to the previous tracing direction (Step S609: YES), the control unit 160 makes an image correction by decreasing the brightness of the specified rectangular areas (Step S611).

When judging in Step S605 that the user operation is not made within the predetermined time period from the previous correction (Step S605: NO), the control unit 160 makes an image correction by increasing the brightness of the specified rectangular areas (Step S606). Step S606 is also performed when it is judged in Step S607 that the specified rectangular areas are different from the rectangular areas subjected to the previous correction (Step S607: NO) or when it is judged in Step S609 that the tracing direction is the same as the previous tracing direction (Step S609: NO).

Next, the control unit 160 causes the display unit 120 to display the corrected image on the image display area 121.

The processing steps described above are performed by the mobile phone 100 to make a rectangular-area correction.

The following describes specific examples of image corrections made by performing the processing steps of the of flowcharts shown by FIGS. 5 and 6.

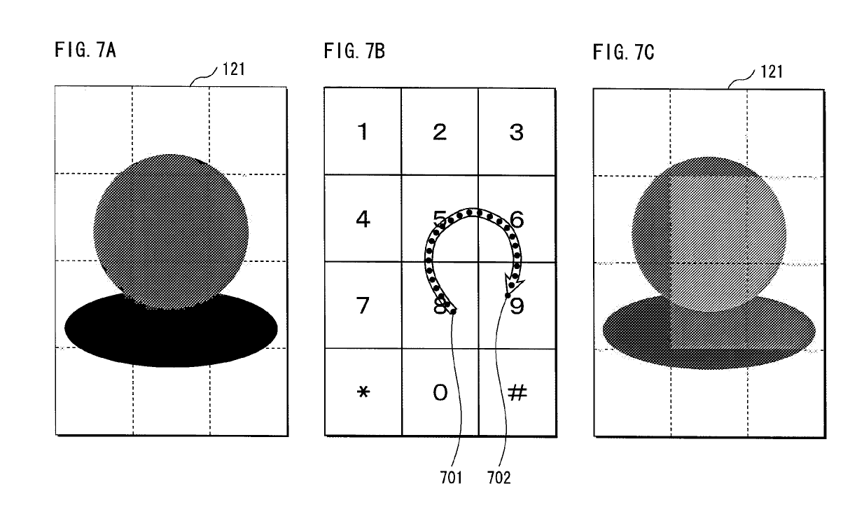

FIGS. 7A-7C show a specific example of a rectangular-area correction of increasing the brightness of the specified rectangular areas. More specifically, FIG. 7A shows a display image displayed on the image display area 121 before the correction. FIG. 7B shows the path of a user operation. FIG. 7C shows a display image displayed on the image display area 121 after the correction.

In order to make a correction on the displayed image as shown in FIG. 7A, the user makes an operation of touching the touchpad 141 with his finger and moving the finger across the touchpad 141 as indicated by the arrow shown in FIG. 7B. Note that the dots enclosed within the arrow shown in FIG. 7B represent some of the points obtained by plotting the series of coordinates actually detected by the touchpad 141. By sequentially connecting the dots, the path of the user operation across the touchpad 141 is obtained as indicated by the arrow shown in FIG. 7B. Note that a point 701 is the start point and a point 702 is the end point of the user operation path. Hereinafter, a “start point” and an “end point” used in the specification refer to the corresponding points of an arrow shown in the related figures.

The control unit 160 specifies Rectangular Areas “5”, “6”, “8”, and “9”, based on the series of coordinates detected by the touchpad 141 and indicated by the arrow. Subsequently, the control unit 160 corrects the display image by uniformly increasing the brightness of the specified rectangular areas of the image display area 121. As a result, the corrected image as shown in FIG. 7C is displayed on the image display area 121. As apparent from the comparison between FIGS. 7A and 7C, the brightness of Rectangular Areas “5”, “8”, and “9” are increased and thus the portions of the display image displayed within those rectangular areas are brighter in FIG. 7C than in FIG. 7A.

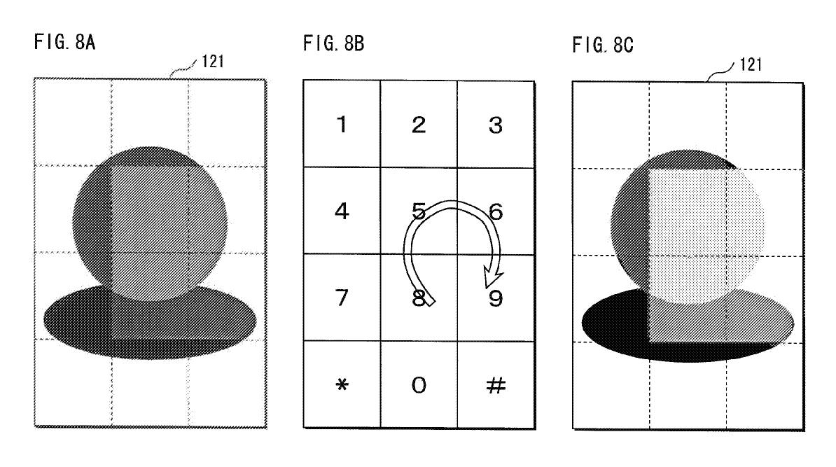

FIGS. 8A-8C show a specific example of a rectangular-area correction performed subsequently to the rectangular-area correction shown in FIGS. 7A-7C. This subsequent correction is made to further increase the brightness of the specified rectangular areas. FIG. 8A shows a display image before the subsequent correction. FIG. 8B shows the path of a user operation. FIG. 8C shows a display image after the subsequent correction.

As shown in FIG. 8A, the image displayed before the subsequent correction is the same as the image shown in FIG. 7C. In order to further increase the brightness of the image shown in FIG. 8A, the user makes another operation of moving his finger across the touchpad 141 as indicated by the arrow shown in FIG. 8B.

The touchpad 141 sequentially detects and outputs the series of coordinates indicating the user operation path to the control unit 160. In response, the control unit 160 specifies Rectangular Areas “5”, “6”, “8”, and “9” and subsequently judges that those rectangular areas are the same as the rectangular areas subjected to the previous correction. In addition, the control unit 160 judges that the tracing direction of the current user operation is the same as the tracing direction of the previous user operation. Consequently, the control unit 160 further increases the brightness of the same rectangular areas as the previous correction. As a result, the corrected image as shown in FIG. 8C is displayed on the image display area 121. As apparent from FIG. 8C, the brightness of Rectangular Areas “5”, “6”, “8”, and “9” is further increased and thus the portions of the display image displayed within those rectangular areas are brighter.

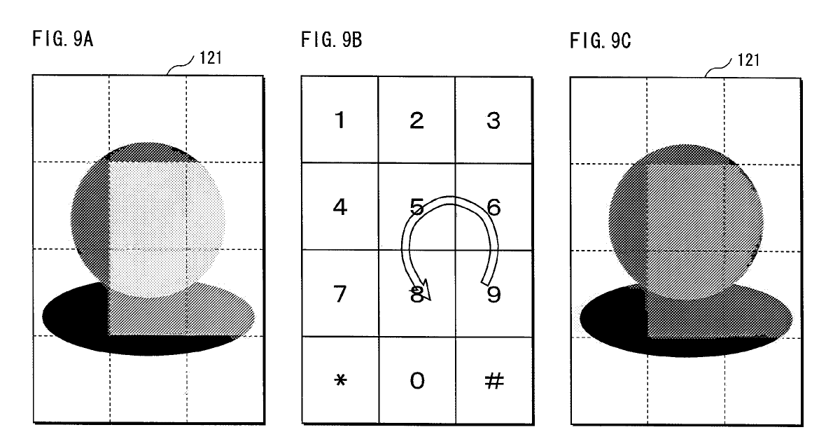

FIGS. 9A-9C show a specific example of an image correction requested by the user when the user feels that the brightness of the display image as shown in FIG. 8C is increased to excessively. The image correction shown in FIGS. 9 in one specific example in which Steps S609 and S611 of the flowchart shown in FIG. 6 are performed.

In the specific example shown in FIGS. 9A-9B, the image correction is made to decrease the brightness. FIG. 9A shows a display image before the correction and thus is identical to the display image shown in FIG. 8C. FIG. 9B shows the path of a user operation. FIG. 9C shows a display image after the subsequent correction.

When the user feels that the brightness of the display image shown in FIG. 9A has been increased to excessively, the user may request an image correction to decrease the brightness. In order to request such an image correction, the user makes an operation by moving his finger across the touchpad 141 in a counterclockwise direction as shown in FIG. 9B. That is, the tracing direction of the user operation is in reverse to the tracing direction of the previous user operation. Based on the series of coordinates sequentially detected by the touchpad 141, the control unit 160 sequentially specifies Rectangular Areas “9”, “6”, “5”, and “8” in the stated order. Subsequently, the control unit 160 judges that those rectangular areas are the same as the rectangular areas subjected to the previous correction and that the tracing direction of the current user operation in reverse to the tracing direction of the previous user operation. Consequently, the control unit 160 decreases the brightness of the four specified rectangular areas of the image display area 121.

As a result, the display unit 120 displays the display image corrected by decreasing the brightness of Rectangular Areas “9”, “6”, “5”, and “8” as shown in FIG. 9C.

As described above, in response to a user operation that is made in a reverse tracing direction to that of the previous user operation, the mobile phone 100 performs an image correction to decrease the brightness. That is to say, the mobile phone 100 is configured to specify one or more rectangular areas and to perform a correction process by increasing or decreasing the brightness of the specified rectangular areas.

### Correction Process 2

Correction Process 1 allows the user to specify one or more rectangular areas of the image display area 121. Correction process 2 described below allows the user to specify a portion of the image display area 121 so that the specified portion more closely corresponds to a user operation in terms of location, size and/or shape.

In order to execute Correction Process 2, the user selects, form a menu for example, a non-rectangular-area correction or makes such settings in advance.

In response to a user operation touching the touchpad 141 with his finger and moving the finger across the touchpad 141, the touchpad 141 outputs a series of coordinates describing the path of the user operation to the control unit 160. The control unit 160 transforms the series of coordinates detected on the touchpad 141 to a corresponding series of coordinates on the image display area 121 and adjusts the brightness of a portion the display image corresponding to a path on the image display area 121 designated by the transformed coordinates.

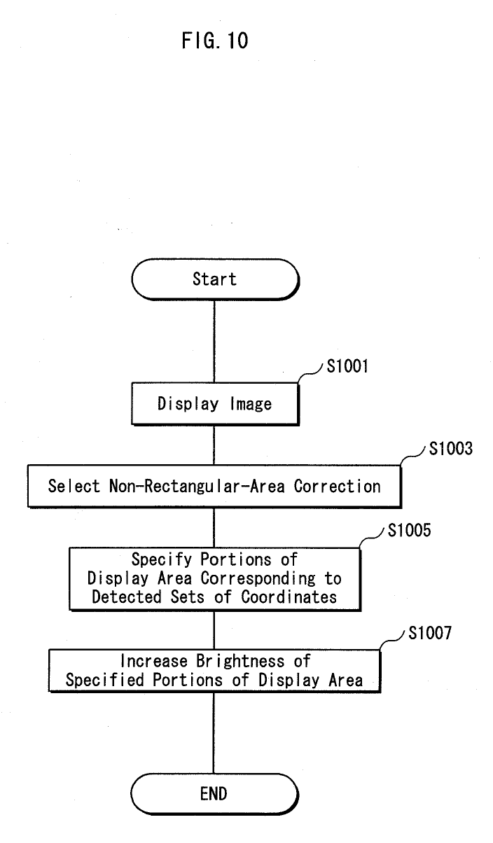

The following describes the processing steps of the mobile phone 100 performed for executing a non-rectangular-area correction to precisely specifying a portion of the display image in response to a user operation and adjust the brightness of the specified image portion. In the description, reference is made to a flowchart shown in FIG. 10.

Under control by the control unit 160 of the mobile phone 100, the display unit 120 displays an image (Step S1001).

In response to a user input, such as a menu selection, made on the operation unit 140 to select a non-rectangular-area correction, the control unit 160 makes corresponding setting (Step S1003).

The control unit 160 transforms the series of coordinates detected on the touchpad 141 to corresponding coordinates on the image display area 121 (Step S1005). In the case of this particular embodiment, the coordinate system of the touchpad 141 is equal in scale to the coordinate system of the image display area 121. Thus, the coordinate transformation is made simply at a one-to-one ratio. In other words, the coordinates of a point on the touchpad 141 is directly usable as the coordinates of a corresponding point on the image display area 121 without coordinate transformation.

The control unit 160 increases the brightness of a portion of the display image corresponding to the series of coordinates (Step S1007). As a result, the display unit 120 displays the thus corrected image on the image display area 121.

The following describes specific examples of how the display image is corrected by executing Correction Process 2.

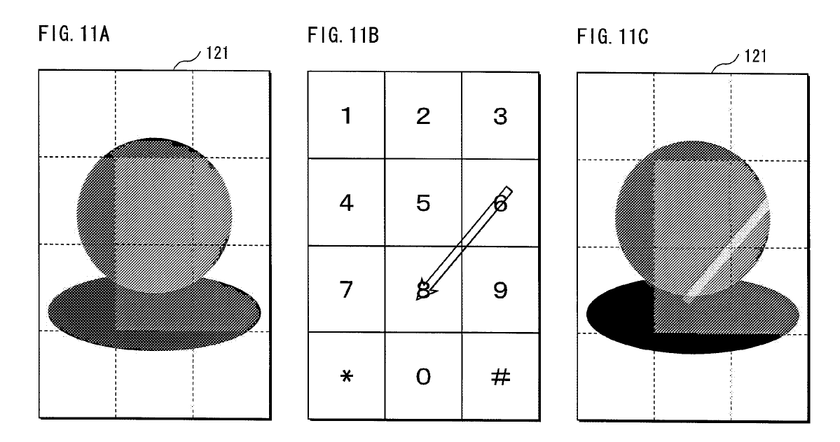

FIGS. 11A-11C show a specific example of Correction Process 2 performed subsequently to Correction Process 1. More specifically, FIG. 11A shows a display image before Correction Process 2. Naturally, the display image shown in FIG. 11A is identical to the display image shown in FIG. 9C. FIG. 11B shows a path of the user operation. FIG. 11C shows a display image after Correction Process 2.

In order to further increase the brightness of a portion of the display image shown in FIG. 11A, the user makes an operation of touching the touchpad 141 with his finger and moving the finger across the touchpad 141 as indicated by the arrow shown in FIG. 11B. In response, the touchpad 141 sequentially detects a series of coordinates describing the path of the user operation and outputs the detected coordinates to the control unit 160. The control unit 160 calculates corresponding coordinates on the image display area 121 by coordinate transformation and increases the brightness of a portion of the display image corresponding to a path described by the calculated coordinates.

As a result, the control unit 160 causes the display unit 120 to display the corrected image as shown in FIG. 11C. As apparent from the comparison between FIGS. 11A and 11C, the portion of the display image corresponding to the user operation path is brighter in FIG. 11C than in FIG. 11A. Note that that in a non-rectangular-area correction, the width of a portion to be specified and corrected with respect to a user operation path is determined in advance.

It is not necessary to perform Correction Process 2 always after a rectangular-area correction process. Correction Process 2 may be solely performed or after any other correction process.

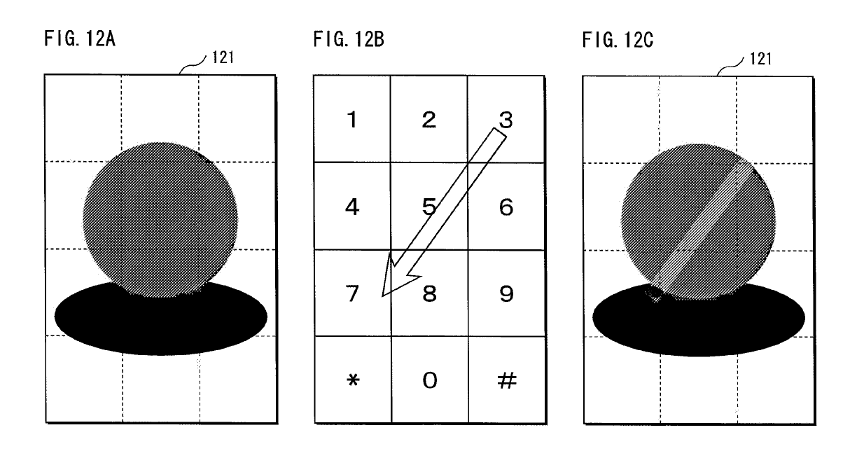

For example, Correction Process 2 may be performed as the first correction made on the on a display image as shown in FIG. 12A.

FIG. 12A shows the display image before any correction. FIG. 12B shows the path of a user operation made on the touchpad 141. FIG. 12C shows a display image after Correction Process 2.

As shown in FIGS. 12, the mobile phone 100 is able to perform Correction Process 2, even if any rectangular-area correction process is not performed prior to Correction Process 2.

### Correction Process 3

The following describes Correction Process 3.

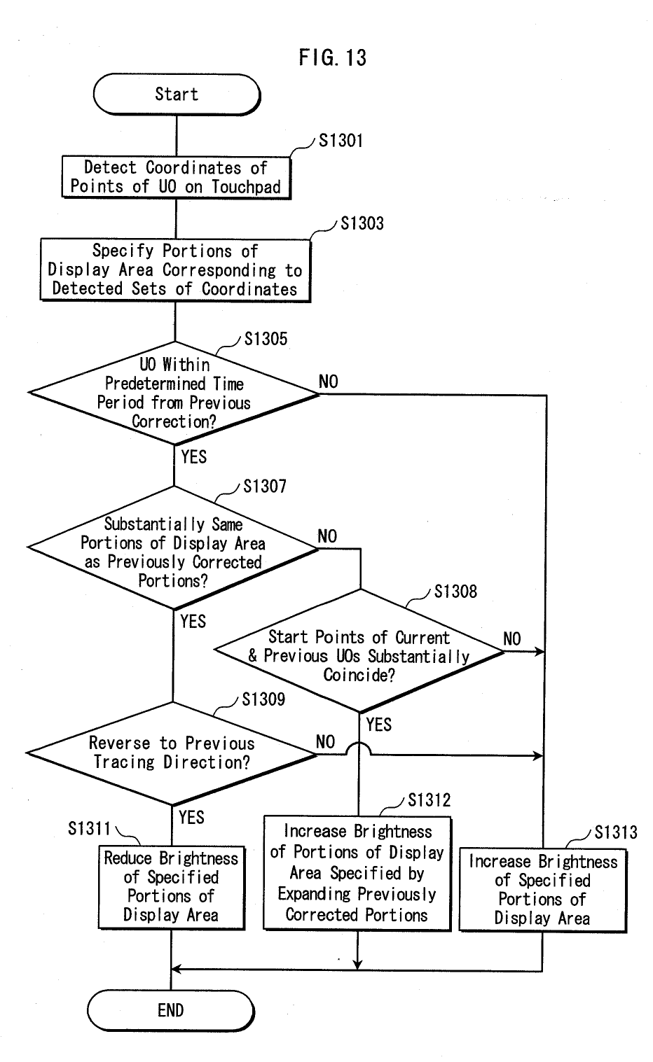

With reference to a flowchart shown in FIG. 13, the mobile phone 100 performs an image correction in response to a user operation made subsequently to a previous user operation.

In response to a user operation of touching the touchpad 141, the touchpad 141 sequentially detects a series of coordinates describing the path of the user operation and outputs the detected coordinates to the control unit 160 (Step S1301).

The control unit 160 transforms the coordinates detected on the touchpad 141 to corresponding coordinates on image display area 121 and specifies a portion of the display image to be corrected (Step S1303).

Next, the control unit 160 judges whether the current user operation is made within a predetermined time period (five seconds, for example) from the previous correction (Step S1305). This judgment in Step S1305 is made by calculating the difference between the time at which the previous image correction is made and the time at which the current user operation is received, and determining whether the calculated difference is equal to or shorter than a predetermined time period.

When judging that the current user operation is made within the predetermined time period (Step S1305: YES), the control unit 160 then judges whether the portion of the display image specified to be corrected substantially coincides with the portion of the display image previously corrected (Step S1307). The judgment in Step S1307 is made to see if the respective portions “substantially” coincide. This is to allow for a human error or deviation naturally expected between the previous and current user operation paths when a human intends to trace exactly the same path as the previous user operation. In view of this, the judgment in Step S1307 is made to see if the difference between the respective paths falls within a predetermined margin. The predetermined margin is determined in advance by actual measurement to achieve an adequate level of practicality.

When judging that the respective portions of the display image substantially coincide with each other (Step S1307: YES), the control unit 160 then judges whether the tracing direction is in reverse to the previous tracing direction (Step S1309). This judgment is made based on whether or not the series of coordinates describing the user operation path are detected sequentially in the same order as in the previous correction process.

When judging that the tracing direction is in reverse to the previous tracing direction (Step S1309: YES), the control unit 160 decreases the brightness of the specified portion of the display image (Step S1311).

When judging in Step S1307 that the specified portion of the display image does not coincide with the previously corrected portion (Step S1307: NO), the control unit 160 then judges whether the start point of the current user operation substantially coincides with the start point of the previous user operation (Step S1308). This judgment in Step S1308 is made by calculating the distance between the current and previous start points based on the respective sets of coordinates and determining whether the calculated distance is within a predetermined distance.

When judging that the respective start points substantially coincide (Step S1308: YES), the control unit 160 specifies a larger portion of the display image to be corrected as compared with the previously corrected image portion and subsequently increases the brightness of the specified portion of the display image (Step S1312). More specifically, the control unit 160 specifies a portion of the image display area 121 having two edges extending from the start point to the respective end points.

When judging that the user operation is not made within the predetermined time period from the previous correction (Step S1305: NO) or that the current start point does not substantially coincide with the previous start point (Step S1308: NO), the control unit 160 simply increases the brightness of the portion of the display image specified in response to the current user operation (Step S1313).

The following describes the processing steps of the flowchart shown in FIG. 13, by way of specific examples.

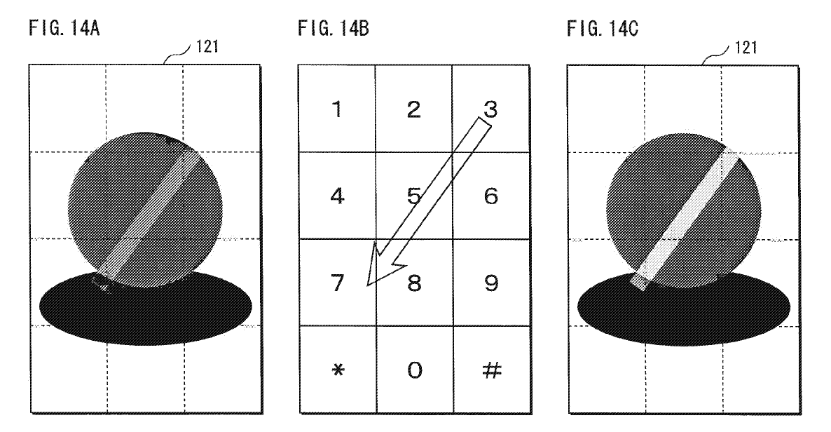

FIGS. 14A-14C show a specific example of how the display image is corrected by executing a non-rectangular-area correction subsequently to a previous correction. The subsequent correction is executed to further increase the brightness of the previously corrected portion of the display image.

FIG. 14A shows a display image before the subsequent correction. FIG. 14B shows a path of the user operation. FIG. 14C shows a display image after the subsequent correction.

In order to increase the brightness of the display image presented on the image display area 121 as shown in FIG. 14A, the user makes a user input, such as a menu selection, to select a non-rectangular-area correction. Subsequently, the user makes a user operation of touching the touchpad 141 with his finger and moving the finger across the touchpad 141 as indicated by an arrow shown in FIG. 14B. The control unit 160 sequentially detects a series of coordinates describing the path of the user operation. Subsequently, the control unit 160 specifies a portion of the display image corresponding to the series of coordinates and increases the brightness of the specified portion of the display image. As a result, the display image corrected as shown in FIG. 14C is displayed on the image display area 121. As apparent from the comparison between FIGS. 14A and 14C, the brightness of the portion of the display image specified correspondingly to the user operation path is further increased. Thus, the corrected portion shown in FIG. 14A is brighter than in FIG. 14C.

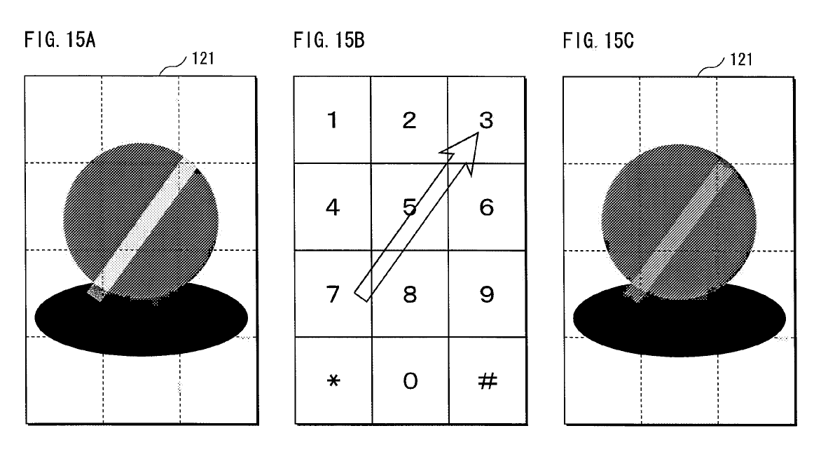

FIG. 15A-15C show a specific example of an image correction of decreasing the brightness of a previously corrected portion of a display image. Such an image correction may be requested by the user when the user feels that the brightness has been increased too excessively.

FIG. 15A shows the display image presented on the image display area 121. The display image shown in FIG. 15A is identical to the display image shown in FIG. 14C and the user feels that the brightness has been increased too excessively. In order to make an image correction that counteracts the previous correction of increasing the brightness, the user makes an operation of touching the touchpad 141 to substantially trace the path of the previous user operation in the reverse direction, as indicated by the arrow shown in FIG. 15B.

The touchpad 141 sequentially detects a series of coordinates describing the path of the user operation indicated by the arrow shown in FIG. 15B. Subsequently, the control unit 160 specifies a portion of the image display area 121 corresponding to the detected coordinates.

The control unit 160 then decreases the brightness of the specified portion of the display image. As a result, the display unit 120 displays the corrected image as shown in FIG. 15C. As apparent from the comparison between FIGS. 15A and 15C, the brightness of the portion of the display image corresponding to the user operation path is decreased. Thus, the corrected portion of the display image is darker in FIG. 15C than in FIG. 15A.

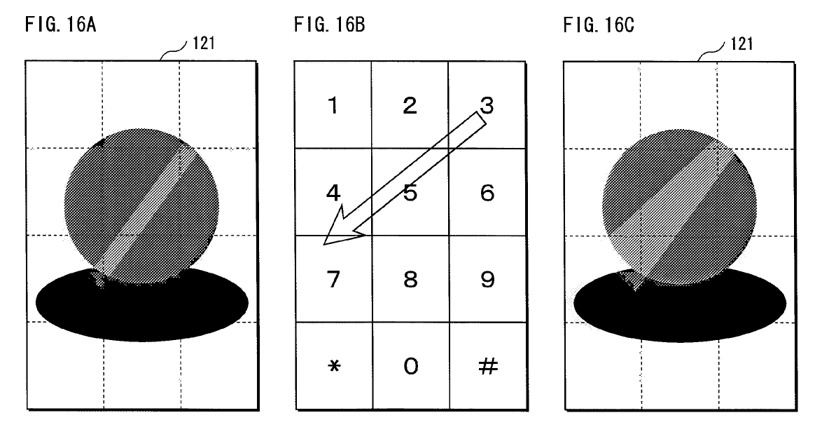

FIGS. 16A-16B show a specific example of a correction made in Step S1312 of the flowchart shown in FIG. 13.

More specifically, FIG. 16A shows a display image before the correction. The display image shown in FIG. 16A is previously corrected once by increasing the brightness and thus is identical to the display image shown in FIG. 12C.

In order to make a correction on a larger portion of the display image than the previously corrected portion, the user makes an operation as indicated by FIG. 16B. That is, the user initiates the user operation by touching, with his finger, a point on that substantially coincide with the start point of the previous user operation shown in FIG. 12B. Subsequently, the user moves the finger across the touchpad 141 into a direction toward a point away from the end point of the previous user operation in order to expand the portion to be specified as compared with the previously corrected portion.

When judging that the user operation is made within the predetermined time period from the previous correction, the control unit 160 increases the brightness of a portion of the display image defined by connecting the start point to the respective end points of the previous and current user operation paths. As a result, the display unit 120 displays the image corrected as shown in FIG. 16C.

As apparent from the comparison between FIGS. 16A and 16C, the brightness of the portion of the display image enclosed between the previous and current user operation paths is increased. Thus, the corrected portion is brighter in FIG. 16C than in FIG. 16A.

As described above, by successively making a first user operation in combination with a second user operation, the user is allowed to request an image correction on a portion of the displayed image specified by a wide variety of ways.

### Correction Processing 4

The following describes Correction Process 4 which is another non-rectangular-area correction process. Thus, Correction Process 4 allows the user to specify a portion of the image display area 121 in units other than the rectangular areas shown in FIG. 2.

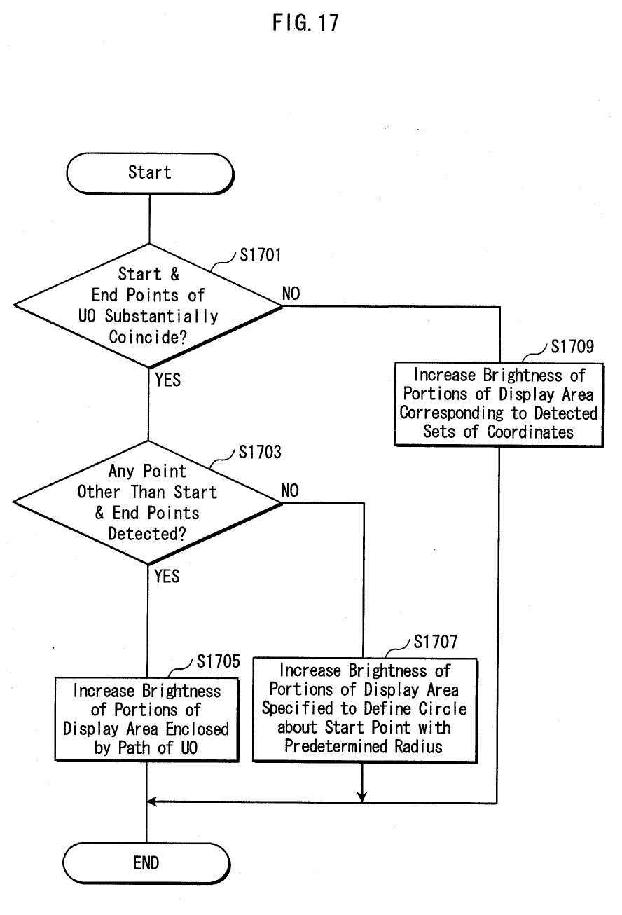

First of all, with reference to the flowchart shown in FIG. 17, the processing steps of the mobile phone 100 performed to execute Correction Method 4 are described. Note that the processing steps of Correction Method 4 are to be performed subsequently to Step S1005 of the flowchart shown in FIG. 10.

The control unit 160 judges whether or not the start point and end point of the detected user operation path substantially coincide with each other (Step S1701).

When judging that the start and end points substantially coincide (Step S1701: YES), the control unit 160 further judges whether the touchpad 141 has been detected any point other than the start and end points (Step S1703).

When judging that a point other than the start and end points has been detected (Step S1703: YES), the control unit 160 specifies a portion of the display image enclosed within the user path described by the series of coordinates detected by the touchpad 141 and increases the brightness of the specified portion of the display image (Step S1709).

When judging that no other point than the start and end points has been detected (Step S1703: NO), the control unit 106 increases the brightness of a circular portion of the display image, provided that the user operation of continually touching the point is made for a predetermined duration or longer (Step S1707). Note that the circular portion is determined to have a predetermined radius and the center coincident at the point commonly regarded as the start and end points. The storage unit 150 stores information indicating the radius determined in advance by the designer of the mobile phone 100.

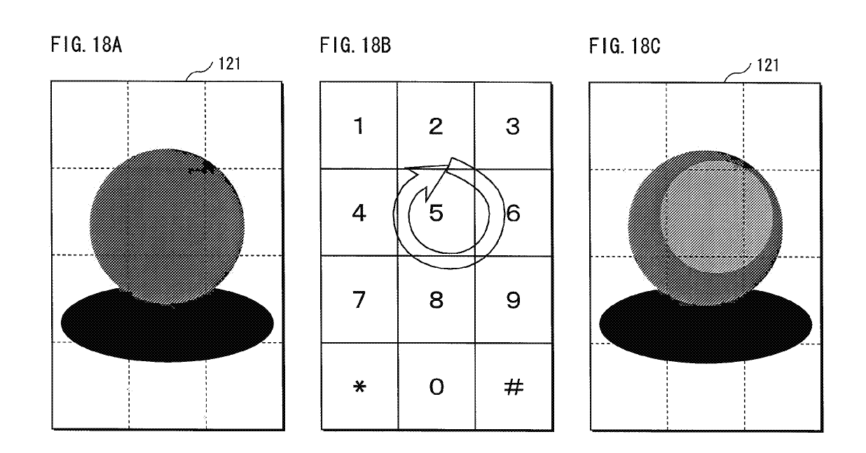

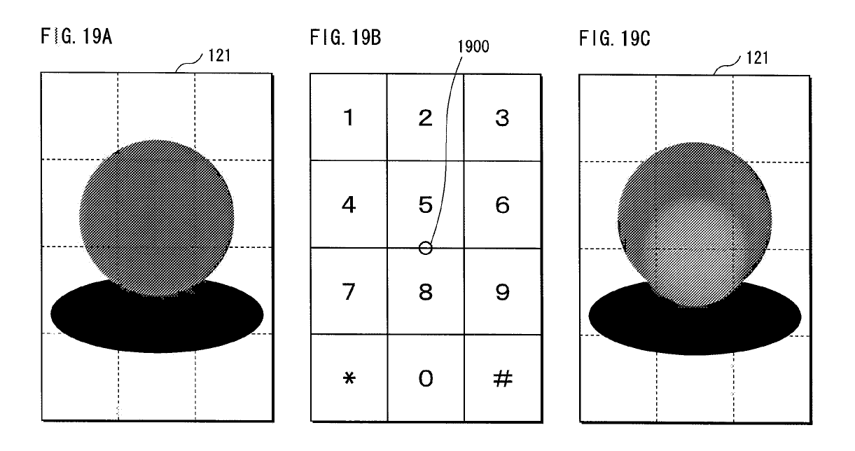

On judging that the start and end points do not coincide with each other (Step S1701: NO), the control unit 160 increases the brightness of the portion of the display image specified in the same manner as shown in FIG. 10 (Step S1709) FIGS. 18A-18C and 19A-19C show specific examples of images corrected by executing the processing steps of the flowchart shown in FIG. 17.

More specifically, FIG. 18A shows a display image before the correction. FIG. 18B shows the path of a user operation. FIG. 18C shows a display image after the correction.

In response to a user operation of touching the touchpad 141 with his finger and moving the finger across the touchpad 141 as indicated by the arrow shown in FIG. 18B, the control unit 160 sequentially detects a series of coordinates describing the path of the user operation. On judging that the start and end points of the user operation path substantially coincide with each other, the control unit 160 specifies a portion of the display image enclosed within a line defined by sequentially connecting the points in the order of the detection. Then, the control unit 160 increases the brightness of the specified portion of the display image. As a result, the image corrected as shown in FIG. 18C is displayed on the display unit 120.

As apparent from the comparison between FIGS. 18A and 18C, the brightness of the portion of the display image corresponding to an area of the touchpad 141 enclosed within the user operation is increased.

FIGS. 19A-19C show a specific example of an image correction made in response to a user operation of continually touching a substantially single point on the touchpad 141.

More specifically, FIG. 19A shows a display image before the correction. FIG. 19B shows a touch point on the touchpad 141. FIG. 19C shows a display image after the correction.

In order to make an image correction of increasing the brightness of the display image shown in FIG. 19A, the user makes an operation of continually touching a point 1900 on the touchpad 141 as shown in FIG. 19B.

In response, the control unit 160 detects that the touch point substantially remains unmoved, i.e., the start and end points of the user operation path substantially coincide with each other. On detecting that the duration of the user operation reaches a predetermined time period, the control unit 160 specifies a circular portion of the display image having the center corresponding to the detected touch point and increases the brightness of the thus specified circular portion. Note that the brightness is increased so that the circular portion has a blurred outline as shown in FIG. 19C. The control unit 160 then causes the display unit 120 to display the thus corrected image.

As described above, by making a user operation of tracing a circular path on the touchpad 141, the user is allowed to make a correction of increasing the brightness of a portion (a circular portion, for example) of the display image corresponding to an area of the touchpad 141 enclosed within the user operation path. In addition, by a simple operation of touching a single point on the touchpad 141, the user is also allowed to make an image correction of increasing the brightness of a portion of the display image surrounding the point corresponding to the touch point. That is, the user is allowed to adjust the brightness of any portion of the display image as desired.

### Correction Process 5

In Correction Process 5, a portion of a display image to be corrected is specified in accordance with the tracing speed at which user's finger is moved across the touchpad 141 to make a user operation.

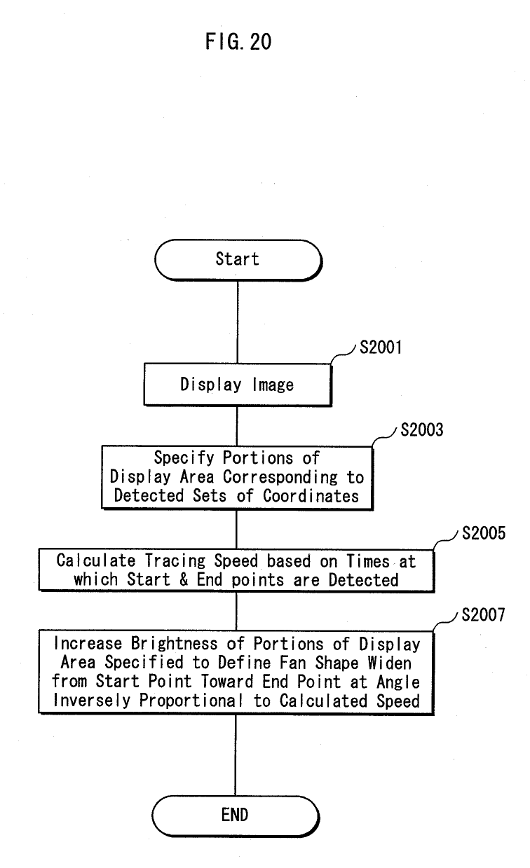

FIG. 20 shows a flowchart of processing steps performed by the mobile phone 100 to execute Correction Process 5.

First, the display unit 120 displays an image on the image display area 121 (Step S2001).

In response to a user operation by touching the touchpad 141 with his finger and moving the finger across the touchpad 141, the touchpad 141 sequentially detects a series of coordinates describing the path of the user operation. Based on the detected coordinates, the control unit 160 specifies a portion of the display image to be corrected (Step S2003).

The point on the touch pad 141 at which the user's finger first touches to start the continual touch is designated as the start point. Similarly, the point on the touchpad 141-at which the user's finger is moved off to end the continual touch is defined as the end point. The control unit 160 records the times at which the start and end points are respectively detected. Subsequently, the control unit 160 calculates the distance between the start and end points and also calculates the difference by subtracting the detection time of the start point from the detection time of the end point. Based on the calculated difference and distance, the control unit 160 calculates the speed at which the user's finger is moved across the touchpad 141 to make the user operation (Step S2005). Hereinafter, the speed is referred to simply as the “tracing speed”.

The control unit 160 specifies a portion of the display image to be corrected based on the calculated tracing speed and increases the brightness of the specified portion of the display image. More specifically, the portion of the display image is specified to define a shape that outwardly expands toward the end point of the user operation at an angle determined in relation to the tracing speed. In order to determine an expansion angle, the storage unit 150 stores, in advance, one or more thresholds each associated with a specific expansion angle.

The control unit 160 then causes the display unit 120 to display the image corrected by increasing the brightness of the thus specified portion.

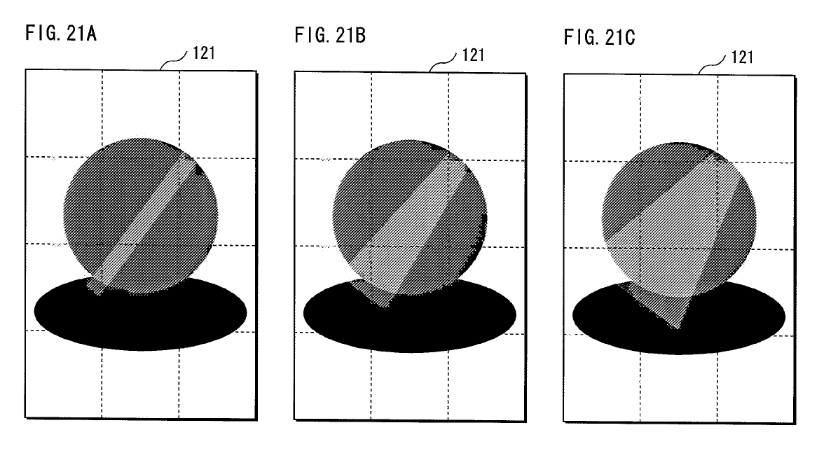

FIGS. 21A-21C show showing how the display image is corrected by executing Correction Process 5.

More specifically, FIGS. 21A-21C show the display images after the correction made on the display image shown in FIG. 12A in response to the user operation of tracing the user operation path shown in FIG. 12B at different tracing speeds.

FIG. 21A is the display image corrected in the case where the tracing speed is equal to or higher than a first threshold. FIG. 21B is the display image corrected in the case where the tracing speed is lower than the first threshold and equal to or higher than a second threshold. FIG. 21C shows the display image corrected in the case where the tracing speed is lower than the second threshold.

As apparent from FIGS. 21A-21C, in response to the user operation made at a faster tracing speed, a narrower portion of the display image (i.e., a portion that expands at a smaller angle) is specified and corrected as shown in FIG. 21A. On the other hand, in response to the user operation made at a slower tracing speed, a larger portion of the display image (i.e., a portion that expands at a larger angle) is specified and corrected as shown in FIG. 21C.

As in Correction Process 5 described above, the mobile phone 100 allows the user to specify a different size of portion of the display image, simply by changing the tracing speed and thus without the need to make any other input such as a menu selection.

### Correction Process 6

The following describes Correction Process 6 in which a portion of the display image to be corrected is specified in response to two successive user operations.

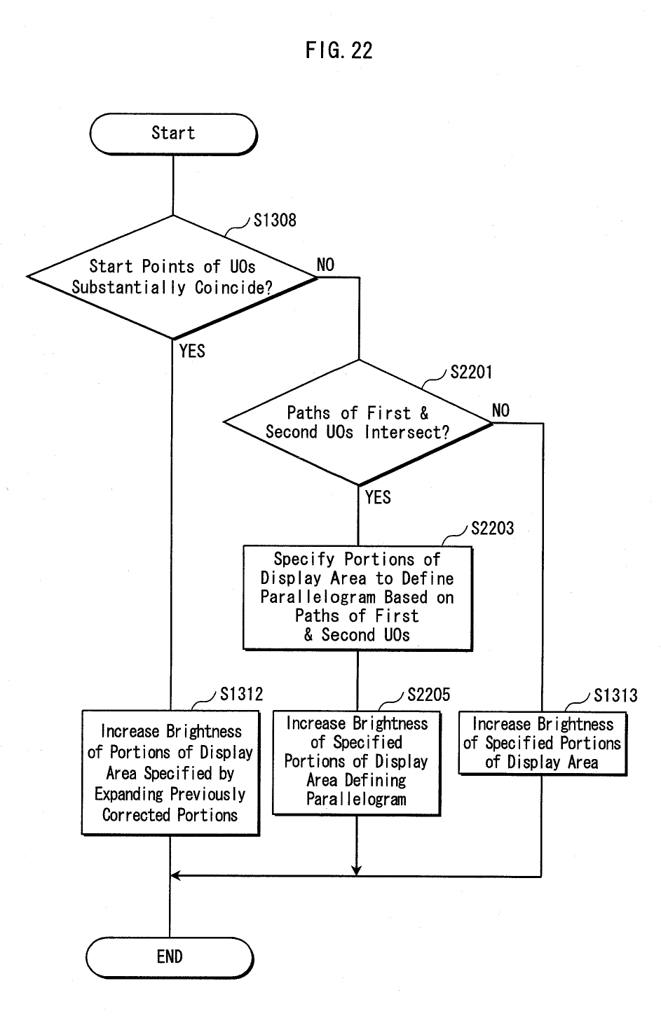

FIG. 22 is a flowchart of processing steps performed by the mobile phone 100 to execute Correction Process 6.

The processing steps of the flowchart shown in FIG. 22 is performed subsequently to when the control unit 160 makes the negative judgment in Step S1308 of the flowchart shown in FIG. 13. Thus, the first processing step shown in FIG. 22 is Step S1308 of judging whether the respective start points of the previous and current user operation paths substantially coincide with each other. The following description relates only to the processing steps specific to Correction Process 6 and the description of the processing steps performed prior to Step S1308 is omitted to avoid redundancy.

When judging that the respective start points of the first and second user operation paths do not substantially coincide with each other (Step S1308: NO), the control unit 160 then judges whether the paths of the first and second user operations intersect with each other (Step S2201). This judgment in Step S2201 is made based on the line segments described by the respective series of coordinates detected in the first and second user operations.

When judging that the paths of the first and second user operations intersect with each other (Step S2201: YES), the control unit 160 specifies a portion of the display image corresponding to an area of the touchpad 141 enclosed within a parallelogram having one vertex at the intersection point and other two vertices at the end points of the first and second paths (Step S2203).

The control unit 160 then increases the brightness of the thus specified portion of the display image (Step S2205). As a result, the display unit 120 displays the thus corrected image.

When judging that the paths of the first and second user operations do not intersect with each other (Step S2201: NO), the control unit 160 specifies a portion of the display image according to the second user operation and increases the brightness of the thus specified portion of the display image (Step S1313).

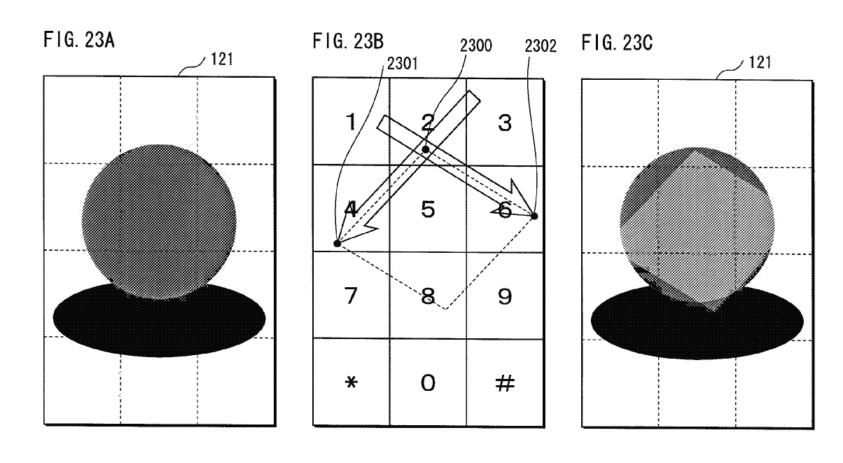

FIGS. 23A-23C show a specific example of Correction Process 6.

More specifically, FIG. 23A shows a display image before the correction. FIG. 23B shows the paths of first and second user operations. FIG. 23C shows a display image after the correction.

Suppose that the user successively makes two user operations of tracing the paths indicated by the arrows shown in FIG. 23B within the predetermined time period. In response to each of the two successive user operations, the touchpad 141 sequentially outputs the series of coordinates describing the path of the user operation to the control unit 160. Based on the respective series of coordinates, the control unit 160 judges that the paths of the first and second user operations intersect with each other. Subsequently, the control unit 160 calculates the coordinates locating a point 2300 at which the respective paths intersect.

The control unit 160 also calculates the coordinates of an end point 2301 of the first user operation and the coordinates of an end point 2302 of the second user operation and defines parallelogram having three of the four vertices coincident at the points 2301, 2302, and 2300. In FIG. 23B, the thus defined parallelogram is shown with dotted lines.

The control unit 160 then increases the brightness of a portion if the display image corresponding to an area of the touchpad 141 enclosed within the thus specified parallelogram. As a result, the display unit 120 displays the corrected image as shown in FIG. 23C. In FIG. 23C, the parallelogram portion of the display image is brighter.

As described above, the mobile phone 100 is enabled to make a rectangular-area correction. The mobile phone 100 is also enabled to more closely specify and correct a portion of the image display area 121 in units other than the rectangular areas shown in FIG. 2, in response to various user operations.

### 4. Supplemental Note

Up to this point, the present invention has been described by way of the above embodiment. It should be naturally appreciated, however, that the present invention is not limited to the specific embodiment. Various modifications including the following may be made without departing from the gist of the present invention.

(1) The present invention may be embodied as a method of executing any of the image correction processes described in the above embodiment. Further, the present invention may also be embodied as a computer program to be loaded to and executed on a mobile phone for executing the image correction method.

Still further, the present invention may be embodied as a recording medium storing the computer program. Examples of such a recording medium include FD (Flexible Disc), MD (Magneto-optical Disc), CD (Compact Disc), and BD (Blu-ray Disc).

(2) In the above embodiment, the mobile phone is described as one example of an image display device. However, an image display device according to the present invention is not limited to a mobile phone. The present invention is applicable to any other device having a display and a ten-key pad that doubles as a touchpad. Examples of such display devices include a PDA (Personal Digital Assistants) having numeric and other keys having touch sensitive surfaces acting as a touchpad.

(3) According to the above embodiment, the image correction is made to adjust brightness only. Yet, an image correction may be made to adjust other aspects of a display image including the value and chroma.

In addition, the brightness of a display image may be adjusted by altering only one of RGB components in the case where the display is configured to make RGB output. For example, the brightness of a display image may be adjusted by altering the brightness of the R (Red) components only.

(4) In addition to the image correction processes described above, the image display device according to the present invention may be configured to perform various other image correction processes including the following.

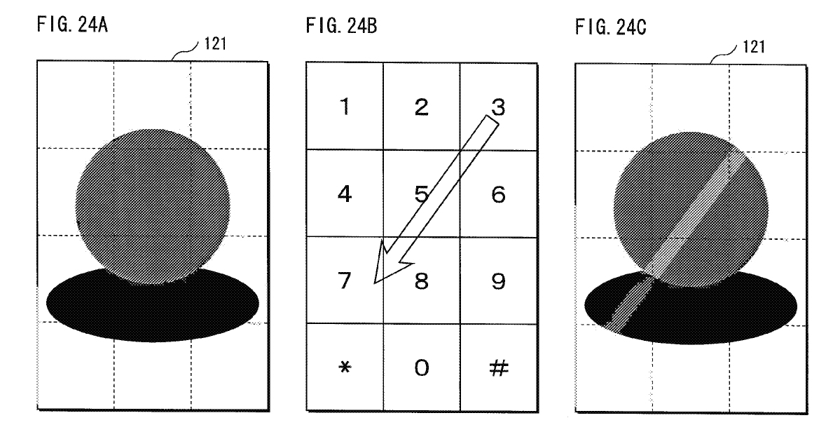

According to the above embodiment, a portion of a display image to be corrected is specified based on a line segment defined by connecting the detected start and end points. Alternatively, the image correction may be made on a portion of the display image specified based on an extended line segment as in a specific example shown in FIGS. 24A-24C. FIG. 24A shows a display image before the correction. FIG. 24B shows the path of a user operation. FIG. 24C shows a display image after the correction. According to the correction process in which the specification is made based on the line segment connecting the start and end points, the display image is corrected as show in FIG. 12C. Yet, in the display image shown in FIG. 24C, the corrected portion of the display image covers a location corresponding to the line segment extending from the start point beyond the end point.

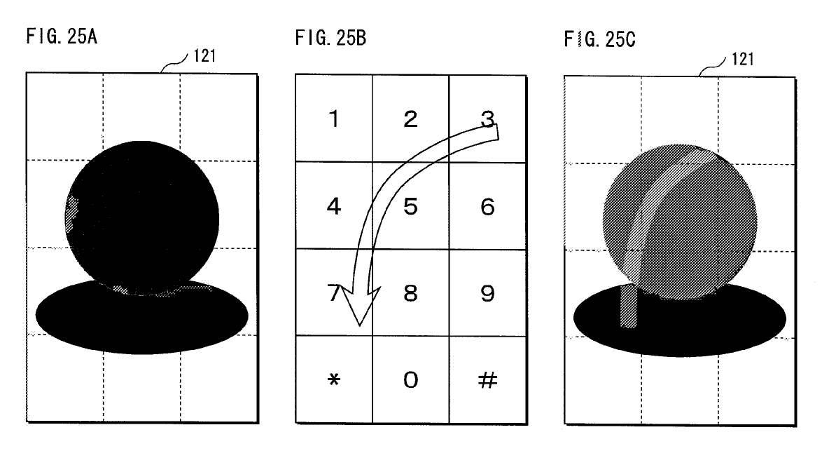

In the above embodiment, the path of a user operation is described as a straight line. In practice, however, the path of a user operation is seldom totally straight. Rather, it is often the case where the path of a user operation is curved as shown in FIG. 25B. Naturally, the mobile phone 100 specifies a portion of the display image corresponding to the curved path. As a result, the display image shown in FIG. 25A is corrected as shown in FIG. 25C. It is apparent from FIG. 25C that the corrected portion of the display image defines a curved line conforming to the curved path of the user operation.

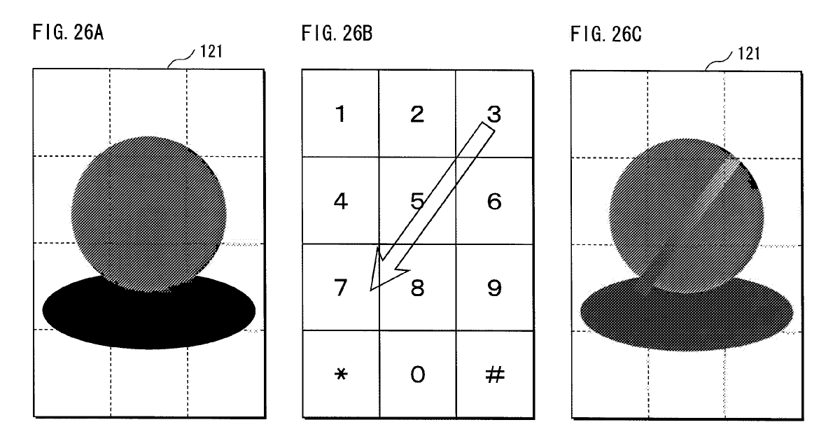

According to the above embodiment, the brightness of the specified portion of the display image is adjusted by uniformly increasing or decreasing the brightness level. Alternatively, however, the correction may be made by correcting the brightness of the specified portion of the display image, so that part of the specified portion is brighter at a location closer to the start point and darker at a location closer to the end point as shown in FIG. 26C. FIG. 26A shows a display image before the correction. FIG. 26B shows the path of a user operation. FIG. 26C shows the display image after the correction.

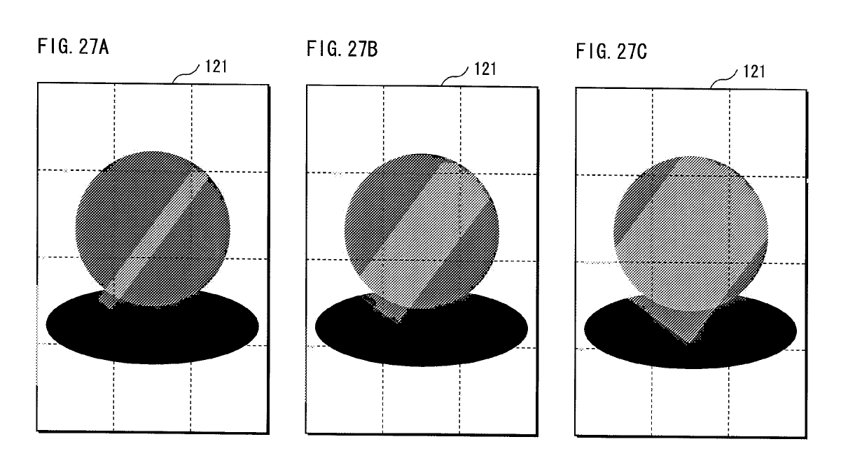

According to Correction Process 5 described above, the specified portion of the display image outwardly expands from the start point toward the end point at an angle larger inversely with the tracing speed. Alternatively, the portion of the display image is specified so that the width of the specified portion with respect to the tracing direction is uniformly wider. FIGS. 27A-27C show specific examples of the modified Correction Process 5. FIG. 27A shows the display image corrected in response to the user operation made at a tracing speed that is equal to or higher than a first threshold. FIG. 27B shows the display image corrected in response to the user operation made at a tracing speed that lower than the first threshold and equal to higher than a second threshold. FIG. 27C shows the display image corrected in response to the user operation made at a tracing speed that lower than the second threshold. As apparent from the comparison of FIGS. 21A-21C, the specified portions are made larger by uniformly increasing the width of the specified portion according to the tracing speed. In the specific examples shown in FIGS. 21A-21C, the specified portions are made to radially expand at a larger angle as the tracing speed is lower.

(5) According to the above embodiment, the mobile phone 100 allows the user to selectively make a rectangular-area correction and a non-rectangular-area correction. Alternatively, the mobile phone 100 may be modified to allow the user only either of a rectangular-area correction and a non-rectangular-area correction. This modification eliminates the need for selecting one of the rectangular-area and non-rectangular-area corrections in advance, by a menu selection for example. Thus, the user's trouble required for executing a correction process is reduced.

(6) According to Correction Process 4 described above, in response to a user operation of continually touching a point on the touchpad 141 for the predetermined period or longer, a circular portion of the display image having a predetermined radius is specified. Subsequently, the specified circular portion is corrected by increasing the brightness in a manner that the outline of the circular portion is blurred. According to one modification, instead of specifying a circular portion having the predetermined radius, the radius of the circular portion may be made larger in proportion to the duration of the continual touch. This modification allows the user to specify an image portion of any desired radius, simply by continually touching a point on the touchpad 141.

(7) Correction Process 4 described above may be modified so that the brightness of the specified portion of the image is increased or decreased to an extent proportional to the duration of a user operation of continually touching the touchpad 141. This modification allows the user to adjust the brightness of the specified portion of the display image to any desired extent, simply by continually touching a point on the touchpad 141.

(8) In Correction Process 5 described above, a portion of the display image to be specified and corrected expands from the start point toward the end point at a larger angle inversely with the tracing speed. Although the description mentions only three examples shown in FIGS. 21A-21C in which the specified portions having mutually different sizes (i.e., expansion angles), it does not mean that the size of an image portion to be specified is variable among three levels. The size of image portion to be specified may be variable among five levels. Alternatively, the size of image portion to be specified may be continuously variable inversely with the tracing speed, rather than stepwise.

(9) According to the above embodiment, the coordinate systems of the touchpad 141 and of the image display area 121 have the same scale and thus the coordinates of a point on the touchpad 141 are directly usable, without coordinate transformation, as coordinates locating a corresponding point on the image display area 121. However, there may be a case where the scales of the respective coordinate systems are mutually different. In that case, coordinate transformation needs to be performed at a ratio between the coordinate systems in order to acquire a correspond point on the image display area 121 from the coordinates of a point on the touchpad 141.

(10) According to the above embodiment, a plurality of rectangular areas are specified in response to a user operation of touching a point on the touchpad 141 with his finger and moving the finger across the touchpad 141. Alternatively, the mobile phone 100 may be modified to specify a plurality of rectangular areas in various other ways including the following.

In response to a user operation of touching a point on the touchpad 141, the control unit 160 regards that the touch is made to a circular area of a predetermined radius having the center at the touch point. Consequently, the control unit 160 specifies a plurality of rectangular areas of the image display area 121 overlapping an area of the touchpad 141 corresponding to the circular area and adjusts the brightens of the specified portion of the display image.

(11) According to the above embodiment, a path of a user operation is designated by moving user's finger across the touchpad 141 while continually touching the touchpad 141 (i.e., without never moving the finger off the touchpad 141 during the user operation). Alternatively, however, the following modification may be made regarding the determination of a user operation path.

That is, suppose that the user makes an operation of momentary touching a first point on the touchpad 141 with his finger and makes another operation of touching a second point on the touchpad 141 within a predetermined time period. According to the modification, the control unit 160 regards the first and second points as the start and end points of one user operation path and specifies a corresponding portion of the display image and adjusts the brightness of the specified portion of the display image.

(12) According to the above embodiment, in the case where the portion of the display image specified in response to a first user operation substantially coincides with the portion specified in response to a second user operation, the image correction in response to the second user operation is conducted on the portion of the image specified in response to the second user operation. Alternatively, however, the image correction in response to the second user operation may be conducted on the image portion specified in response to the first user operation.

(13) In the specific example shown in FIGS. 19 according to the embodiment, a circular portion of the display image having the center at a point corresponding to the touch point is specified and corrected. Alternatively to a circular portion, a portion of any other shape having the center at a point corresponding to the touch point may be specified. Examples of such shapes include a rectangle and a hexagon.

(14) According to the above embodiment, the mobile phone 100 increases the image brightness in Step S509 shown in FIG. 5. Alternatively, however, the mobile phone 100 may be modified to decrease the image brightness in Step S509 shown in FIG. 5 and to increase the image brightness in Step S611 shown in FIG. 6.

(15) According to the above embodiment, each rectangular area of the image display area 121 is specified in response to a user operation of touching a corresponding point on the touchpad 141. However, each rectangular area of the image display area 121 may be specified at a push of a corresponding key of the ten-key pad by the user.

(16) Although not specifically described in the above embodiment, in a non-rectangular-area correction (i.e., Correction Processes 2-6), a portion of the display image is specified in units that are smaller in size than the rectangular areas shown in FIG. 2 and the smaller units may be rectangular in shape.

(17) Although in the above description, a user operation of touching the touchpad 141 is made with a user's finger. However, a user operation of touching the touchpad 141 may be made with any other part of the user's body or with a tool such as a touch pen.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image display device comprising:
a touchpad operable to detect a touch point at which a user operation of touching the touchpad is made;
a display unit operable to display an image on a display area that includes a plurality of sub-areas; and
a brightness adjusting unit operable to specify one or more of the sub-areas based on the touch point and adjust brightness of the specified one or more sub-areas.

2. The image display device according to claim 1, wherein
the touchpad has a first two-dimensional coordinate system and is operable to detect coordinates locating the touch point in the first coordinate system,
the image display area has a second two-dimensional coordinate system, and
the brightness adjusting unit is operable to transform the coordinates in the first coordinate system to corresponding coordinates in the second coordinate system and specify the one or more sub-areas based on the coordinates obtained by the coordinate transformation.

3. The image display device according to claim 2, wherein
the touchpad and the display area each have a rectangular shape,
the sub-areas each have a rectangular area and are obtained by dividing the display area into a two-dimensional array,
the first coordinate system has (i) a first X axis coincident with one edge of the touchpad and (ii) a first Y axis coincident with another edge of the touchpad that is orthogonal to the first X axis,
the second coordinate system has (i) a second X axis coincident with an edge of the display area and (ii) a second Y axis coincident with another edge of the display area that is orthogonal to the second X axis,
the first and second X axes are parallel to each other,
the brightness adjusting unit is operable to correlate, at a predetermined ratio, (i) the first X axis with the second X axis and (ii) the first Y axis with the second Y axis,
the brightness adjusting unit is operable to transform the coordinates locating the touch point along the first X and Y axes to the corresponding coordinates along the second X and Y axes at the predetermined ratio, and
the display unit is operable to display the image based on the second coordinate system.

4. The image display device according to claim 2, further comprising:
a plurality of operation keys disposed in a two dimensional array so as to together form a surface coincident with a sensor surface of the touchpad; and
a communication unit operable to communicate with another device, wherein
the plurality of operation keys include numeric keys for receiving a user input designating a telephone number of an outgoing call,
the sub-areas in the two-dimensional array are in a one-to-one correspondence with the plurality of operation keys, and
the brightness adjusting unit is operable to specify one or more of the operation keys corresponding to the touch point and specify the one or more sub-areas corresponding to the specified operation keys.

5. The image display device according to claim 2, further comprising:
a detecting unit operable to detect, based on a plurality of touch points sequentially detected by the touchpad during the user operation of making a continual touch across the touchpad, a user-operation path defined by connecting the sequentially detected touch points, wherein
the brightness adjusting unit is operable to specify the one or more sub-areas based on the user-operation path.

6. The image display device according to claim 5, wherein
the detecting unit is operable to determine (i) a start point at which the continual touch is initiated as a start point of the user-operation path and (ii) a point at which the continual touch is released as an end point of the user-operation path,
in response to a second user operation made subsequently to a first user operation, the brightness adjusting unit is operable to judge (i) whether a user-operation path of the second user operation substantially coincides with a user-operation path of the first user operation, (ii) whether a start point of the second user-operation path substantially coincides with an end point of the first user-operation path and (iii) whether an end point of the second user-operation path substantially coincides with a start point of the first user-operation path, and
if the judgments (i), (ii), and (iii) all result in the affirmative, the brightness adjusting unit is operable to adjust the brightness of the one or more sub-areas specified in response to the first user operation, by increasing or decreasing the brightness to counteract a previous adjustment made in response to the first user operation.

7. The image display device according to claim 5, wherein
the detecting unit is operable to determine (i) a start point at which the continual touch is initiated as a start point of the user-operation path and (ii) a point at which the continual touch is released as an end point of the user-operation path, and
the brightness adjusting unit is operable to specify the one or more sub-areas based on a line segment defined by connecting the start and end points.

8. The image display device according to claim 7, wherein
the brightness adjusting unit is operable to specify the one or more sub-areas based on coordinates locating a point residing on a line segment extended from the start point beyond the end point.

9. The image display device according to claim 5, wherein
the brightness adjusting unit is operable to judge (i) whether the start and end points of the user-operation path substantially coincide with each other and (ii) whether the user-operation path contains any point other than the start and end points, and
if the judgments (i) and (ii) both result in the affirmative, the brightness adjusting unit is operable to specify the one or more sub-areas based on an area enclosed within the user-operation path.

10. The image display device according to claim 5, wherein
the brightness adjusting unit is operable to judge (i) whether the start and end points of the user-operation path substantially coincide with each other and (ii) whether the user-operation path contains any point other than the start and end points, and
if the judgment (i) results in the affirmative and the judgment (ii) results in the negative, the brightness adjusting unit is operable to specify the one or more sub-areas based on an area containing the start point.

11. The image display device according to claim 5, wherein
if the detecting unit detects a first user-operation path and a second user-operation path in succession within a predetermined time period, the brightness adjusting unit is operable to specify the one or more sub-areas based on both the first and second user-operation paths.

12. The image display device according to claim 11, wherein
if the first and second user-operation paths intersect with each other, the brightness adjusting unit is operable to specify the one or more sub-areas based on an area enclosed within a parallelogram having vertices coincident with the intersection point and the end points of the first and second user-operation paths.

13. The image display device according to claim 5, wherein
if the detecting unit detects a second user-operation path subsequently to a first user-operation path within a predetermined time period from the detection of the first user-operation path, the brightness adjusting unit is operable to judge whether the second user-operation path substantially coincides with the first user-operation path, and
if the judgment results in the affirmative, the brightness adjusting unit is operable to further adjust the brightness of the one or more sub-areas specified in response to the first user operation.

14. The image display device according to claim 5, wherein
the detecting unit is operable to detect a tracing speed at which a point of the continual touch is moved across the touchpad, based on (i) times at which the start and end points of the user-operation path are respectively detected and (ii) a length of the user-operation path, and
the brightness adjusting unit is operable to specify the one or more sub-areas based on the touch points and tracing speed detected by the detecting unit.

15. The image display device according to claim 14, wherein
the brightness adjusting unit is operable to specify the one or more sub-areas so as to cover a larger portion of the display area as the tracing speed is slower.

16. The image display device according to claim 15, wherein
the brightness adjusting unit is operable to specify the one or more sub-areas together defining a substantial fan shape that outwardly expands from the start point toward the end point at an angle that is larger as the tracing speed is slower.

17. The image display device according to claim 5, wherein
the brightness adjusting unit is operable to adjust the brightness by a predetermined level.

18. The image display device according to claim 5, wherein
the brightness adjusting unit is operable to adjust the brightness, so that the specified one or more sub-areas are gradually brighter at a location closer to the start point than at a location closer to the end point.

19. An image correction program for execution by a computer of an image display device, the display device having a touchpad and a display unit for displaying an image on a display area composed of a plurality of sub-areas, the program comprising code operable to cause the computer to perform the following steps to adjust brightness of the image:
a detecting step of detecting a touch point at which a user operation of touching the touchpad is made; and
a brightness adjusting step of specifying one or more of the sub-areas based on the touch point and adjust brightness of the one or more sub-areas.

20. An image correction control device comprising:
an acquiring unit operable to acquire a touch point at which a user operation of touching a touchpad is made; and
a control unit operable to (i) specify one or more of sub-areas that together constitute a display area of a display that is for displaying an image thereon and (ii) adjust brightness of the specified one or more sub-areas.
